(19) United States
(12) Patent Application Publication
(10) Pub. No.: US 2012/0060722 A1
(43) Pub. Date: Mar. 15, 2012

(54) BITUMINOUS BINDER FOR PREPARING LOW-TEMPERATURE ASPHALT OR COATED MATERIALS

(75) Inventors: Alain Montpeyroux, Saint Martin La Plaine (FR); Laurence Lapalu, Villeurbanne (FR); Joël Herault, Saint Sorlin (FR); Benoit Thiebaut, Lyon (FR); Roland Devis, Nevele (BE)

(73) Assignee: TOTAL RAFFINAGE MARKETING, PUTEAUX (FR)

(21) Appl. No.: 13/321,002

(22) PCT Filed: May 18, 2010
(86) PCT No.: PCT/IB10/52209

§ 371 Date: Nov. 17, 2011

(30) Foreign Application Priority Data
May 19, 2009 (FR) 0902423

(51) Int. Cl. C08L 95/00

(52) U.S. Cl. 106/235; 106/232; 106/500

(57) ABSTRACT

The present disclosure relates to a bituminous binder including bitumen and at least two additives making it possible to reduce the manufacturing, processing and compacting temperatures of mixes and asphalts, the first additive being a Tall Oil derivative, alone or in a mixture, and the second additive being a monoester of a mixture of fatty acids. The disclosure also relates to low-temperature methods for the preparation of the mixes and asphalts obtained from the binder containing additives. The disclosure finally relates to the use of the binder containing additives in order to produce mixes and asphalts at lower temperatures, and the use of these mixes or asphalts, in particular in road applications, for sub-base courses, base courses, foundation courses, surface courses such as binder courses and/or wearing courses.

### CROSS-REFERENCE TO RELATED APPLICATIONS

This application is a National Phase Entry of International Application No. PCT/IB2010/052209, filed on May 18, 2010, which claims priority to French Patent Application Serial No. FR 0902423, filed on May 19, 2009, both of which are incorporated by reference herein.

### TECHNICAL FIELD

The present invention relates to a bituminous binder containing additives, comprising bitumen and at least two additives making it possible to reduce the manufacturing, processing and compacting temperatures of the mixes and to reduce the manufacturing and processing temperatures of the asphalts. The first additive is a Tall Oil derivative, alone or in a mixture, and the second additive is a monoester of a mixture of fatty acids. The invention also relates to the mixes (mix bituminous coatings or bituminous mixes) and asphalts obtained from said bituminous binder to which the Tall Oil derivative and the fatty acid monoester have been added.

The invention also relates to low-temperature methods for preparing the mixes and asphalts obtained from said bituminous binder to which the Tall Oil derivative and the fatty acid monoester have been added. The invention finally relates to the use of the Tall Oil derivative and the fatty acid monoester in a bituminous binder and the use of said bituminous binder to which the Tall Oil derivative and the fatty acid monoester have been added, in order to produce mixes and asphalts at lower temperatures. The invention also relates to the use of these mixes or asphalts for the manufacture of surfacing materials for roads, carriageways, footways, road systems, urban developments, floors, waterproofing of buildings or of civil engineering works, in particular in road applications for the manufacture of sub-base courses, base courses, foundation courses, surface courses such as binder courses and/or wearing courses.

### BACKGROUND

By asphalt is meant a mixture of bituminous binder with mineral fillers. The mineral fillers are constituted by fines (particles with dimensions less than 0.063 mm), sand (particles with dimensions comprised between 0.063 mm and 2 mm) and optionally chippings (particles with dimensions greater than 2 mm, preferably comprised between 2 mm and 4 mm). By bituminous mix is meant a mixture of bituminous binder with aggregates and optionally mineral fillers. The aggregates are mineral and/or synthetic aggregates, in particular, recycled cuttings, with dimensions greater than 2 mm, preferably comprised between 2 mm and 14 mm.

Asphalts are mainly used for manufacturing and covering footways, whereas mixes are used for manufacturing roads. Unlike mixes, asphalts are not compacted with a roller when they are laid.

The preparation of the hot mixes or asphalts comprises several stages. The first stage consists of mixing the bituminous binder with aggregates (in the case of the mixes) or with fillers (in the case of the asphalts) at a so-called manufacturing temperature or coating temperature. The bituminous binder/aggregates mixture or the bituminous binder/fillers mixture is then spread (in the case of the mixes) or poured (in the case of the asphalts) at a so-called processing temperature. In the case of the bituminous mixes, there is then a stage of compacting at a so-called compacting temperature. After the compacting of the bituminous mix or the pouring of the asphalt, the bituminous mix or the asphalt are cooled down to ambient temperature.

The different temperatures used in the preparation of the mixes and the conventional asphalts are very high. Thus, in the case of the bituminous mixes, the manufacturing (or coating) and processing temperatures are comprised between 160° C. and 180° C. and the compacting temperature is comprised between 120° C. and 150° C. In the case of the asphalts these temperatures are yet higher, the manufacturing (or coating) and processing temperatures are comprised between 200° C. and 250° C.

These relatively high temperatures lead to high energy expenditure, emissions of greenhouse gases and volatile organic compounds and make working conditions difficult due to the radiation and gas emissions. It is therefore sought to lower the manufacturing, processing and compacting temperatures in the case of the bituminous mixes and the manufacturing and processing temperatures in the case of the asphalts. Solutions for lowering said temperatures have already been proposed.

Thus, Patent Application FR2721936 describes the addition to a thermofusible organic binder, of hydrocarbon waxes such as polymethylene waxes, polyethylene waxes, polypropylene waxes or ethylene-propylene copolymers. The use of these hydrocarbon waxes in the binder makes it possible to lower the manufacturing and processing temperatures of poured asphalts. The additives used in this Application are additives of fossil origin and therefore non-renewable, and are used only for asphalts.

Patent Application FR2855523 proposes the addition to a thermofusible organic binder, of a hydrocarbon wax the melting point of which is greater than 85° C. and of a second additive constituted by a fatty acid ester wax, this wax being of synthetic, plant, or fossil plant origin and having a melting point less than 85° C. The use of these two additives makes it possible to prepare poured asphalts at temperatures comprised between 150° C. and 170° C. The hydrocarbon wax used is an additive of fossil origin and therefore non-renewable. The combination of additives is used only for asphalts.

Patent Application FR2883882 proposes the introduction into a bituminous product of one or more chemical additives, comprising a (poly)oxyethylated and/or (poly)oxypropylated group, in order to lower the production temperature of the aggregates/bituminous product mixtures by between 20° C. and 40° C., the temperature of the aggregates/bituminous product mixture during spreading by between 10° C. and 40° C. and the temperature of the aggregates/bituminous product mixture in the core during compacting, by up to 50° C.

Patent Application FR2878856 describes a bituminous mix comprising aggregates and a binder comprising a hydrocarbon wax the melting point of which is greater than 85° C. and a fatty acid ester wax, this wax being of synthetic, plant, or fossil plant origin and having a melting point of less than 85° C. The use of these two additives makes it possible to prepare bituminous mixes at temperatures comprised between 80° C. and 130° C. The hydrocarbon wax used is an additive of fossil origin and therefore non-renewable.

Patent Application FR2901279 describes a binder comprising two additives. The first additive is a macromolecular compound chosen from natural resins of plant origin or hydrocarbon waxes. The second additive is a fatty acid derivative chosen from the group constituted by the fatty acid diesters and fatty acid ethers. The manufacturing temperatures of the asphalts are comprised between 140° C. and 170° C. The effect of these additives is demonstrated only for the preparation of asphalts.

### SUMMARY

From this viewpoint, the applicant company has sought to reduce the manufacturing, processing and compacting temperatures of the mixes and the manufacturing and processing temperatures of the asphalts. The applicant company has surprisingly established that the addition of at least two compounds of plant and/or animal origin to a bituminous binder makes it possible to significantly reduce the manufacturing, processing and compacting temperatures of the mixes and of the asphalts formulated from said bituminous binder containing additives. The first additive is a Tall Oil derivative, alone or in a mixture and the second additive is a monoester of a mixture of fatty acids.

The main objective of the present invention is therefore to propose a bituminous binder containing additives allowing the formulation of mixes and poured asphalts at lower temperatures, in order to reduce the energy consumption, to reduce combustion gas emission and to reduce fume emissions. In the case of the mixes, the objective is to formulate so-called “warm” mixes and to achieve a coating temperature of 100° C. to 150° C., preferably 110° C. to 140° C., more preferentially 120° C. to 130° C., a processing temperature of 80° C. to 130° C., preferably 90° C. to 120° C., more preferentially 100° C. to 110° C., and/or a compacting temperature of 70° C. to 120° C., preferably 80° C. to 110° C., more preferentially 90° C. to 100° C. In the case of the asphalts, the objective is to achieve a coating temperature of 140° C. to 180° C. and/or a processing temperature of 120° C. to 160° C.

Another objective of the present invention is to propose a bituminous binder containing additives, allowing the formulation of mixes and poured asphalts at lower temperatures, comprising a combination of additives free of non-renewable hydrocarbon compounds of fossil origin, i.e. to propose a bituminous binder to which only renewable, available and inexpensive raw materials have been added. Another objective of the present invention is to propose a bituminous binder containing additives, allowing the formulation of mixes and poured asphalts at lower temperatures, which is economical, as it utilizes a low additive content. Another objective of the present invention is to propose a bituminous binder containing additives allowing the formulation of mixes and poured asphalts at lower temperatures, the mixes or the asphalts having mechanical properties which are equivalent or improved relative to the conventional mixes and asphalts, manufactured in a standard fashion at higher temperatures.

In particular, one of the objectives of the present invention is to propose a warm mix manufactured at lower temperatures, having a good resistance to stripping. In particular, one of the objectives of the present invention is to propose a warm mix manufactured at lower temperatures, having a good resistance to rutting. In particular, one of the objectives of the present invention is to propose a warm mix manufactured at lower temperatures, having a good modulus of rigidity. In particular, one of the objectives of the present invention is to propose an asphalt manufactured at a lower temperature, having the required indentation and shrinkage values.

### BRIEF DESCRIPTION

The invention relates to a bituminous binder comprising at least one bitumen, at least one Tall Oil derivative, alone or in a mixture, and at least one fatty acid monoester. The bituminous binder comprises 0.1 to 5% by mass of Tall Oil derivative and fatty acid monoester, relative to the mass of bituminous binder, notably 0.1 to 4%, and/or 0.1 to 3%, and/or 0.1 to 2%. Preferably, according to one embodiment, the bituminous binder comprises 0.5 to 5% by mass of Tall Oil derivative and fatty acid monoester, relative to the mass of bituminous binder, preferably 1 to 5% by mass. Preferably, according to another embodiment, the bituminous binder comprises 0.1 to 1.5% by mass of Tall Oil derivative and fatty acid monoester, relative to the mass of bituminous binder, preferably 0.5 to 1% by mass.

Preferably, the Tall Oil derivative is chosen from the crude Tall Oils, the distilled Tall Oils, the Tall Oil fatty acids, the Tall Oil resin acids and the Tall Oil pitches, alone or in a mixture. Preferably, the fatty acid monoester is an alkyl monoester chosen from the methyl, ethyl, propyl and butyl monoesters, alone or in a mixture. Preferably, the fatty acid of the fatty acid monoester is a fatty acid comprising 6 to 24 carbon atoms, preferably 14 to 22 carbon atoms, more preferentially 16 to 20 carbon atoms, and advantageously comprising 18 carbon atoms. Preferably the bituminous binder also comprises a polymer. Preferably the bituminous binder also comprises a cross-linking agent.

In a first embodiment, the mass ratio of the Tall Oil derivative to the fatty acid monoester is comprised between 5:95 and 45:55, preferably between 10:90 and 40:60, more preferentially between 20:80 and 30:70. In a second embodiment, the mass ratio of the Tall Oil derivative to the fatty acid monoester is equal to 50:50. In a third embodiment, the mass ratio of the Tall Oil derivative to the fatty acid monoester is comprised between 55:45 and 95:5, preferably between 60:40 and 90:10, more preferentially between 70:30 and 80:20.

The invention also relates to a method for preparing a bituminous binder as defined above, in which the mixing temperature of the bitumen, the Tall Oil derivative and the fatty acid monoester is comprised between 100° C. and 170° C., preferably between 110° C. and 150° C., more preferentially between 120° C. and 130° C. The invention also relates to a bituminous mix comprising a bituminous binder as defined above and aggregates optionally comprising fines, sand and chippings. The invention also relates to an asphalt comprising a bituminous binder as defined above and fillers such as fines, sand and chippings.

The invention also relates to a method for preparing a bituminous mix as defined above, comprising the mixing of the bituminous binder as defined above with aggregates, in which the coating temperature is comprised between 100° C. and 150° C., preferably between 110° C. and 140° C., more preferentially between 120° C. and 130° C. Preferably, the bituminous binder and the aggregates are both at a temperature comprised between 100° C. and 150° C., preferably between 110° C. and 140° C., more preferentially between 120° C. and 130° C., during the coating. Preferably, the processing temperature during the spreading of the bituminous binder/aggregates mixture is comprised between 80° C. and 130° C., preferably between 90° C. and 120° C., more preferentially between 100° C. and 110° C. Preferably, the compacting temperature of the spread mixture is comprised between 70° C. and 120° C., preferably between 80° C. and 110° C., more preferentially between 90° C. and 100° C.

The invention also relates to a method for preparing an asphalt as defined above, comprising the mixing of the bituminous binder as defined above with fillers, in which the manufacturing temperature is comprised between 140° C. and 180° C., preferably between 150° C. and 170° C. Preferably, the bituminous binder and the fillers are both at a temperature comprised between 140° C. and 180° C., preferably between 150° C. and 170° C., during their mixing. Preferably, the processing temperature during the pouring of the bituminous binder/fillers mixture is comprised between 120° C. and 160° C., preferably between 130° C. and 150° C.

The invention also relates to the use of a Tall Oil derivative, alone or in a mixture, and a fatty acid monoester in a bituminous binder for reducing the manufacturing, processing and/or compacting temperatures of a bituminous mix or for reducing the manufacturing and/or processing temperatures of an asphalt. The invention also relates to the use of a bituminous binder as defined above for reducing the manufacturing, processing and/or compacting temperatures of a bituminous mix or for reducing the manufacturing and/or processing temperatures of an asphalt.

The invention finally relates to the use of a mix as defined above or an asphalt as defined above, for the manufacture of surfacing materials for roads, carriageways, pavements, road systems, urban developments, floors, waterproofing of buildings or of civil engineering works, in particular in road applications for the manufacture of sub-base courses, base courses, foundation courses, surface courses such as binder courses and/or wearing courses.

### DETAILED DESCRIPTION

The binder containing additives according to the invention comprises at least one Tall Oil derivative, alone or in a mixture. Tall Oil is a by-product of the paper industry, in particular a by-product of the production of papermaking pulp by the Kraft or sulphate method. Tall Oil is a complex mixture comprising three major families of compounds: resin acids, fatty acids and unsaponifiable neutral products. In general, Tall Oil (or crude Tall Oil) comprises 40 to 60% by mass of resin acids, 30 to 50% by mass of fatty acids and 5 to 10% unsaponifiable neutral products. Crude Tall Oil can be refined by fractional distillation under vacuum and leads to different distillation cuts more or less rich in fatty acids, resin acids and unsaponifiable neutral products. The main distillation cuts are, for example, a cut rich in fatty acids called Tall Oil Fatty Acid (or TOFA), a cut rich in resin acids called Tall Oil resin (or Tall Oil Rosin or TOR) and a cut (or the residue) remaining at the bottom of the distillation column, comprising at the same time fatty acids, resin acids and unsaponifiable neutral compounds called Tall Oil pitch (or TOP).

By Tall Oil derivative, within the meaning of the invention is meant crude Tall Oil or one of the cuts obtained by distillation of the crude Tall Oil, alone or in a mixture. The crude Tall Oil and the different cuts obtained by distillation of the crude Tall Oil can undergo chemical modifications such as hydrogenations, oxidations, dismutations, polymerizations, esterifications, saponifications and/or reactions with maleic anhydride. In particular, the Tall Oil derivative according to the invention is chosen from the crude Tall Oils, distilled Tall Oils, Tall Oil fatty acids, Tall Oil resin acids, Tall Oil pitches, alone or in a mixture.

More preferentially, the Tall Oil derivative according to the invention is chosen from the Tall Oil pitches, alone or in a mixture. The Tall Oil pitches are preferred as they are available, inexpensive and have proved to be particularly effective in lowering the temperatures involved during the manufacture of the mixes and asphalts according to the invention. Moreover, the Tall Oil pitches are compatible with the second additive, which is the fatty acid monoester, and completely soluble in said fatty acid monoester.

Preferably, the Tall Oil derivative according to the invention comprises 10 to 60% by mass of free acids relative to the mass of Tall Oil derivative, preferably 20 to 50%, more preferentially 30 to 40%. Among these free acids, the Tall Oil derivative according to the invention comprises 0.5 to 10% by mass of free fatty acids relative to the mass of Tall Oil derivative, preferably 1 to 5%, more preferentially 2 to 4%. Among these free acids, the Tall Oil derivative according to the invention comprises 0.5 to 20% by mass of free resin acids relative to the mass of Tall Oil derivative, preferably 1 to 15%, more preferentially 5 to 10%. The remainder of the free acids are complex molecules with a high molecular weight.

Preferably, the Tall Oil derivative according to the invention comprises 10 to 50% by mass of acids in esterified form, relative to the mass of Tall Oil derivative, preferably 20 to 40%, more preferentially 25 to 35%. Among these acids in esterified form, the Tall Oil derivative according to the invention comprises 1 to 30% by mass of fatty acids in esterified form, relative to the mass of Tall Oil derivative, preferably 2 to 20%, more preferentially 5 to 10%. Among these acids in esterified form, the Tall Oil derivative according to the invention comprises 0.1 to 10% by mass of resin acids in esterified form relative to the mass of Tall Oil derivative, preferably 1 to 5%, more preferentially 2 to 4%. The remainder of the acids in esterified form are complex molecules with a high molecular weight.

Preferably, the Tall Oil derivative according to the invention comprises 10 to 60% by mass of unsaponifiable neutral compounds, relative to the mass of Tall Oil derivative, preferably 20 to 50%, more preferentially 30 to 40%. Preferably, the fatty acids of the Tall Oil derivative according to the invention are chosen from the palmitic acids, stearic acids, oleic acids, linoleic acids, linolenic acids, alone or in a mixture. Preferably, the fatty acids are chosen from oleic acids and linoleic acids, alone or in a mixture. Preferably, the resin acids of the Tall Oil derivative according to the invention, are chosen from the abietic acids, dehydroabietic acids, palustric acids, isopimaric acids, pimaric acids, neoabietic acids, alone or in a mixture. Preferably the resin acids are chosen from the abietic acids and dehydroabietic acids, alone or in a mixture.

Preferably, the unsaponifiable neutral compounds of the Tall Oil derivative according to the invention comprise terpene derivatives, chosen in particular from the diterpenes and the triterpenes. There can be mentioned the derivatives of diterpene alcohols (or diterpenic alcohols) and triterpene alcohols (or triterpenic alcohols) such as the pimarols, isopimarols, sterols, sitosterols, campesterols, sitostanols, betulinols, alone or in a mixture. The unsaponifiable neutral compounds of the Tall Oil derivative according to the invention also comprise fatty alcohols comprising 8 to 30 carbon atoms, preferably 10 to 24, more preferentially 16 to 22. There can be mentioned for example, the octanols, nonanols, decanols, undecanols, tetradecanols, hexadecanols, octadecanols, docosanols, policosanols, triacontanols, alone or in a mixture.

The Tall Oil derivative according to the invention, has an acid value comprised between 20 and 200 mg KOH/g, preferably between 25 and 190, more preferentially between 35 and 180, even more preferentially between 55 and 160. It is preferable to use a Tall Oil derivative the acid value of which is low and comprised between 10 and 75 mg KOH/g, preferably 20 and 55 mg KOH/g, more preferentially between 25 and 35 mg KOH/g.

The Tall Oil derivative according to the invention has a saponification value comprised between 80 and 200 mg KOH/g, preferably between 100 and 190, more preferentially between 120 and 160. It is preferable to use a Tall Oil derivative the saponification value of which is low and comprised between 50 and 150 mg KOH/g, preferably between 70 and 120 mg KOH/g, more preferentially between 80 and 110 mg KOH/g, even more preferentially between 90 and 100 mg KOH/g.

The Tall Oil derivative according to the invention has a softening point comprised between 10 and 120° C., preferably between 20 and 100° C., more preferentially between 30 and 80° C. It is preferable to use a Tall Oil derivative the softening point of which is comprised between 5 and 80° C., preferably between 10 and 60° C., more preferentially between 20 and 40° C.

The binder containing additives according to the invention also comprises at least one fatty acid monoester. It is understood that this is a monoester of a mixture of several fatty acids, each of the fatty acids being mono-esterified.

The fatty acid esters are obtained by esterification of the free fatty acids or by transesterification of animal and/or vegetable oils (or fatty acid triglycerides) with an alcohol. During the esterification or transesterification, small quantities of fatty acids in the form of monoglyceride, diglyceride, triglyceride or fatty acids in the free form can remain.

Thus, even though the great majority of the fatty acid monoester according to the invention is in the form of monoester, it comprises negligible quantities of fatty acids in the form of monoglyceride, diglyceride, triglyceride or in the free form. The fatty acid monoester according to the invention is more than 80% by mass, preferably between 80 and 90%, more preferentially between 80 and 85% in the form of monoester. The quantities of fatty acids in the form of monoglyceride, diglyceride, triglyceride or in the free form are negligible and represent no more than 15% by mass of fatty acid monoester according to the invention, preferably no more than 10%, more preferentially no more than 6%, even more preferentially no more than 4%.

In particular, the fatty acid monoester according to the invention comprises no more than 5% by mass of fatty acids in the form of monoglyceride, preferably no more than 1%. In particular, the fatty acid monoester according to the invention comprises no more than 5% by mass of fatty acids in the form of diglyceride, preferably no more than 2%. In particular, the fatty acid monoester according to the invention comprises no more than 5% by mass of fatty acids in the form of triglyceride, preferably no more than 1%. In particular, the fatty acid monoester according to the invention comprises no more than 6% by mass of fatty acids in the free form, preferably no more than 3%.

The fatty acids of the fatty acid monoester according to the invention are fatty acids comprising 6 to 24 carbon atoms, preferably 14 to 22 carbon atoms, more preferentially 16 to 20 carbon atoms, the fatty acids comprising 18 carbon atoms being the fatty acids in the majority. Preferably, the quantity by mass of fatty acids comprising 16 carbon atoms of the fatty acid monoester according to the invention relative to the total quantity by mass of fatty acids, is comprised between 10 and 25%, preferably between 15 and 20%. Preferably, the fatty acids comprising 16 carbon atoms are chosen from the palmitic acids and the palmitoleic acids, in particular the palmitic acids.

Preferably, the quantity by mass of fatty acids comprising 18 carbon atoms of the fatty acid monoester according to the invention relative to the total quantity by mass of fatty acids, is comprised between 50 and 85%, preferably between 60 and 80%, more preferentially between 70 and 75%. Preferably, the fatty acids comprising 18 carbon atoms are chosen from stearic acids, oleic acids, linoleic acids, linolenic acids, in particular oleic acids. More preferentially, the quantity by mass of saturated fatty acids comprising 18 carbon atoms (C18:0), relative to the total quantity by mass of fatty acids, is comprised between 1 and 10%, preferably between 2 and 5%. The saturated fatty acids comprising 18 carbon atoms are preferably stearic acids. More preferentially, the quantity by mass of fatty acids comprising 18 carbon atoms and an unsaturation (C18:1), relative to the total quantity by mass of fatty acids, is comprised between 35 and 70%, preferably between 40 and 60%, more preferentially between 50 and 55%. The fatty acids comprising 18 carbon atoms and an unsaturation are preferably oleic acids. More preferentially, the quantity by mass of fatty acids comprising 18 carbon atoms and two unsaturations relative to the total quantity by mass of fatty acids, is comprised between 5 and 45%, preferably between 10 and 40%, more preferentially between 15 and 25%. The fatty acids comprising 18 carbon atoms and two unsaturations are preferably linoleic acids. More preferentially, the quantity by mass of fatty acid comprising 18 carbon atoms and three unsaturations, relative to the total quantity by mass of fatty acids, is comprised between 0.1 and 5%, preferably between 1 and 2%. The fatty acids comprising 18 carbon atoms and three unsaturations are preferably linolenic acids.

The fatty acid monoester according to the invention is a C₁-C₄ alkyl monoester, such as a methyl monoester, an ethyl monoester, an n-propyl monoester, an i-propyl monoester, an n-butyl monoester, an s-butyl monoester, a t-butyl monoester. Preferably, the monoester is a methyl monoester. The acid value of the fatty acid monoester is comprised between 2 and 50 mg KOH/g, preferably between 5 and 10. The iodine value of the fatty acid monoester is comprised between 40 and 120 mg KOH/g, preferably between 50 and 100, more preferentially between 70 and 90.

The bituminous binder containing additives according to the invention comprises 0.1 to 5% by mass Tall Oil derivative and fatty acid monoester relative to the mass of bituminous binder, preferably 0.5 to 5% by mass, more preferentially 1 to 5% by mass. It is preferable to use the lowest possible quantity of these two additives for economic, but also technical reasons. In fact, if these two additives are in significant quantities in the bituminous binder, the properties of the bituminous binder such as the penetrability, the ring and ball temperature, the viscosity, the adhesiveness, the complex modulus and the properties of the bituminous mix obtained from said bituminous binder such as the Duriez resistance, the resistance to rutting and the modulus, can be affected thereby and become too far from those of the binder without additives and the mix obtained from said binder without additives. Thus for example, too great a quantity of fatty acid monoester can make the binder too fluid, which is not desirable. Preferably, the bituminous binder containing additives according to the invention comprises 0.1 to 1.5% by mass of Tall Oil derivative and fatty acid monoester, relative to the mass of bituminous binder, preferably 0.5 to 1%.

The combination of the Tall Oil derivative and the fatty acid monoester is essential to the invention and makes it possible to formulate a bituminous binder containing additives making it possible to reduce the manufacturing, processing and compacting temperatures during the manufacture of mixes and asphalts with very low contents in the bituminous binder. This combination has a high surfactant power and allows a very good adhesiveness and wettability of the bituminous binder vis-à-vis the aggregates, the bituminous binder is very easy to handle, even at lower temperatures than those conventionally used. The quantity of Tall Oil derivative in the bituminous binder and the quantity of fatty acid monoester in the bituminous binder are calculated as a function of the total quantity of these two additives in the bituminous binder given above and the mass ratios of the quantities of Tall Oil derivative to fatty acid monoester. Three different embodiments are envisaged with respect to the mass ratios of the quantity of Tall Oil derivative to that of fatty acid monoester.

In a first embodiment, the bituminous binder containing additives according to the invention comprises a little more Tall Oil derivative than fatty acid monoester. In this first embodiment, the mass ratio of the quantities of Tall Oil derivative to fatty acid monoester is comprised between 55:45 and 95:5, preferably between 60:40 and 90:10, more preferentially between 70:30 and 80:20.

In a second embodiment, the bituminous binder containing additives according to the invention comprises the same amount of Tall Oil derivative and fatty acid monoester. In this second embodiment, the mass ratio of the quantities of Tall Oil derivative to fatty acid monoester is equal to 50:50.

In a third embodiment, the bituminous binder containing additives according to the invention comprises a little less Tall Oil derivative than fatty acid monoester. In this third embodiment, the mass ratio of the quantities of Tall Oil derivative to fatty acid monoester is comprised between 5:95 and 45:55, preferably between 10:90 and 40:60, more preferentially between 20:80 and 30:70.

The bituminous binder according to the invention, comprises at least one bitumen. This bitumen is alone or in a mixture. There can be mentioned firstly the bitumens of natural origin, those contained in deposits of natural bitumen, natural asphalt or bituminous sands. The bitumens according to the invention are also bitumens originating from the refining of crude oil. Bitumens originate from the atmospheric and/or vacuum distillation of oil. These bitumens being able to be optionally blown, visbroken and/or deasphalted. The different bitumens obtained by the refining methods can be combined with each other in order to obtain the best technical compromise. The bitumen can also be a recycled bitumen. The bitumens can be hard or soft grade bitumens. The bitumens according to the invention have a penetrability, measured at 25° C. according to the standard EN 1426, comprised between 5 and 200 1/10 mm, preferably between 10 and 100 1/10 mm, more preferentially between 20 and 60 1/10 mm, even more preferentially between 30 and 50 1/10 mm.

The bituminous binder according to the invention can also comprise at least one polymer. The polymers used are elastomers or plastomers. There can be mentioned for example, as a non-limitative indication, the thermoplastic elastomers such as the random or block styrene and butadiene copolymers, linear or star-shaped (SBR, SBS), or styrene and isoprene (SIS) copolymers, ethylene and vinyl acetate copolymers, the ethylene and methyl acrylate copolymers, the ethylene and butyl acrylate copolymers, the ethylene and maleic anhydride copolymers, the ethylene and glycidyl methacrylate copolymers, the ethylene and glycidyl acrylate copolymers, the ethylene and propene copolymers, the ethylene/propene/diene terpolymers (EPDM), the acrylonitrile/butadiene/styrene terpolymers (ABS), the ethylene/acrylate or alkyl methacrylate/acrylate or glycidyl methacrylate terpolymers and in particular ethylene/methyl acrylate/glycidyl methacrylate terpolymer and ethylene/acrylate or alkyl methacrylate/maleic anhydride terpolymers and in particular ethylene/butyl acrylate/maleic anhydride terpolymer, olefinic homopolymers and copolymers of ethylene (or propylene, or butylene), polyisobutylenes, polybutadienes, polyisoprenes, poly(vinyl chloride), reground rubber, butyl rubbers, polyacrylates, polymethacrylates, polychloroprenes, polynorbornenes, polybutenes, polyisobutenes, polyethylenes or also any polymer used for the modification of bitumens as well as their mixtures. The preferred polymers are the copolymers of styrene and of butadiene.

The styrene and butadiene copolymer has advantageously a content of styrene from 5% to 50% by mass, relative to the copolymer mass, preferably from 20% to 40%. The styrene and butadiene copolymer has advantageously a content of butadiene from 50% to 95% by mass, relative to the copolymer mass, preferably from 60% to 80%.

Among the butadiene monomer, one will distinguish those with 1-4 double bonds issued from butadiene and those with 1-2 double bonds issued from butadiene. By monomer with 1-4 double bonds issued from butadiene, one will understand those monomers obtained via a 1,4 addition during polymerization of butadiene. By monomer with 1-2 double bonds issued from butadiene, one will understand those monomers obtained via a 1,2 addition during polymerization of butadiene. The result of this 1,2 addition is a vinylic double bond said to be “pendant”. The styrene and butadiene copolymer has a content of monomer with 1-2 double bonds issued from butadiene between 5% and 50% by mass, relative to the total mass of butadiene monomers, preferably between 10% and 40%, more preferably between 15% and 30%, and more advantageously between 18% and 23%.

The styrene and butadiene copolymer has a mean molecular weight M_{W} between 4 000 et 500 000 daltons, preferably between 10 000 and 200 000, more preferably between 50 000 and 150 000, and more advantageously between 80 000 and 130 000, and even more advantageously between 100 000 and 120 000. the molecular weight is measured by GPC chromatography, with a polystyrene standard according to standard ASTM D3536 (replaced by standard ASTM D5296-05). The styrene and butadiene copolymer can be linear or star-shaped, under diblock, triblock or multiarmed. The styrene and butadiene copolymer can also comprise a random hinge. A mixture of styrene and butadiene copolymers is also possible. In general a quantity of polymer of 1 to 20% by mass relative to the mass of bituminous binder, preferably 5 to 10% is used.

This polymer can optionally be cross-linked. The cross-linking agents which can be used are by nature very varied and are chosen as a function of the type(s) of polymer(s) contained in the bituminous binder according to the invention. Preferably, the cross-linking agent is chosen from sulphur alone or in a mixture with vulcanization accelerators. These vulcanization accelerators are either hydrocarbyl polysulphides, or sulphur-donor vulcanization accelerators, or non-sulphur-donor vulcanization accelerators. The hydrocarbyl polysulphides can be chosen from those which are defined in the patent FR2528439. The sulphur-donor vulcanization accelerators can be chosen from the thiurame polysulphides such as, for example, tetrabutylthiurame disulphides, tetraethylthiurame disulphides and tetramethylthiurame disulphides. The non-sulphur-donor vulcanization accelerators which can be used according to the invention can be sulphur-containing compounds chosen in particular from mercaptobenzothiazole and its derivatives, the dithiocarbamates and derivatives thereof, and the thiurame monosulphides and derivatives thereof. There can be mentioned for example zinc-2-mercaptobenzothiazole, zinc dibutyldithiocarbamate and tetramethylthiurame monosulphide. For more details on the sulphur-donor and non-sulphur-donor vulcanization accelerators which can be used according to the invention, reference can be made to the patents EP0360656, EP0409683 and FR2528439. In general, a quantity of cross-linking agent of 0.1 to 2% by mass relative to the mass of bituminous binder is used.

It is also possible to add adhesiveness additives and/or surfactants to the bituminous binder containing additives according to the invention. They are chosen from the alkylamine derivatives, alkyl polyamine derivatives, alkyl amidopolyamine derivatives, alkyl amidopolyamine derivatives, and quaternary ammonium salt derivatives, alone or in a mixture. The most used are the tallow propylene diamines, tallow amidoamines and quaternary ammoniums obtained by quaternization of tallow propylene-diamines and tallow propylene-polyamines. The quantity of adhesiveness additives and/or surfactants in the bituminous binder containing additives according to the invention is comprised between 0.2% and 2% by mass, preferably between 0.5% and 1% by mass.

A subject of the invention is also a method for preparing a bituminous binder containing additives, in which the mixing temperature of the bitumen, the Tall Oil derivative and the fatty acid monoester is comprised between 100° C. and 170° C., preferably between 110° C. and 150° C., more preferentially between 120° C. and 130° C. A subject of the invention is also a method for preparing so-called warm bituminous mixes, in which a bituminous binder containing additives according to the invention is mixed with aggregates. The method is characterized by the fact that the mixing or coating of the aggregates with the bituminous binder takes place at a particularly low temperature, the coating or manufacturing temperature of the mix being comprised between 100° C. and 150° C., preferably between 110° C. and 140° C., more preferentially between 120° C. and 130° C.

During coating, the aggregates and the bituminous binder containing additives are either both at the same temperature between 100° C. and 150° C., preferably between 110° C. and 140° C., more preferentially between 120° C. and 130° C., or the bituminous binder containing additives is at a temperature of approximately 160° C. and the aggregates are at a temperature between 100° C. and 150° C., preferably between 110° C. and 140° C., more preferentially between 120° C. and 130° C. Because of the significant quantity of aggregates relative to the bituminous binder containing additives (almost 95% by mass aggregates relative to 5% by mass bituminous binder containing additives), it is the temperature of the aggregates which dictates the overall coating temperature which is therefore between 100° C. and 150° C., preferably between 110° C. and 140° C., more preferentially between 120° C. and 130° C. It is preferable to use the aggregates at a temperature between 100° C. and 150° C., preferably between 110° C. and 140° C., more preferentially between 120° C. and 130° C. and the bituminous binder containing additives at the same temperature between 100° C. and 150° C., preferably between 110° C. and 140° C., more preferentially between 120° C. and 130° C. Given that the addition to the bituminous binder of the Tall Oil derivative and the fatty acid monoester does not affect the viscosity of the bituminous binder and does not reduce the latter, when the viscosity of the bituminous binder is too great to allow the pumping of the bituminous binder, it is then preferable to use the bituminous binder containing additives at approximately 160° C. and the aggregates at a temperature between 100° C. and 150° C., preferably between 110° C. and 140° C., more preferentially between 120° C. and 130° C., the overall coating temperature then still being comprised between 100° C. and 150° C., preferably between 110° C. and 140° C., more preferentially between 120° C. and 130° C. In this case, the bituminous binder containing additives is preferably at a temperature comprised between 120° C. and 180° C., preferably between 140° C. and 160° C. and the aggregates at a temperature between 100° C. and 150° C., preferably between 110° C. and 140° C., more preferentially between 120° C. and 130° C., the overall coating temperature still being comprised between 100° C. and 150° C., preferably between 110° C. and 140° C., more preferentially between 120° C. and 130° C.

Although the coating temperature is lower in the method according to the invention, the coating is of good quality and the coating time is not increased relative to a conventional method at a higher temperature. Thus the coating time of the method according to the invention is comprised between 2 seconds and 120 seconds, preferably between 5 seconds and 60 seconds, more preferentially between 10 seconds and 40 seconds.

Once the aggregates are coated, the bituminous binder containing additives/aggregates mixture is spread. The processing temperature during the spreading of the bituminous binder/aggregates mixture is comprised between 80° C. and 130° C., preferably between 90° C. and 120° C., more preferentially between 100° C. and 110° C. The whole mixture is then compacted and the compacting temperature of the spread mixture is comprised between 70° C. and 120° C., preferably between 80° C. and 110° C., more preferentially between 90° C. and 100° C. The whole mixture is then cooled down to ambient temperature.

Another subject of the invention is a method for preparing poured asphalts, in which a bituminous binder containing additives according to the invention is mixed with fillers. The method is characterized by the fact that the mixing of the fillers with the binder takes place at a particularly low temperature, the manufacturing temperature of the asphalt being comprised between 140° C. and 180° C., preferably between 150° C. and 170° C. It should be noted that during manufacture, the fillers and the bituminous binder containing additives are both at the same temperature (between 140° C. and 180° C., preferably between 150° C. and 170° C.). Then, the bituminous binder containing additives/fillers mixture is poured. The processing temperature during the pouring of the bituminous binder/fillers mixture is comprised between 120° C. and 160° C., preferably between 130° C. and 150° C. The whole mixture is then cooled down to ambient temperature.

A subject of the invention is also bituminous mixes comprising a bituminous binder according to the invention, aggregates and optionally fillers. The bituminous mix comprises 1 to 10% by mass of bituminous binder containing additives, relative to the total mass of the mix, preferably 4 to 8% by mass. Another subject of the invention is poured asphalts comprising a bituminous binder according to the invention and mineral fillers. The asphalt comprises 1 to 20% by mass bituminous binder containing additives relative to the total mass of the asphalt, preferably 5 to 10% by mass.

A subject of the invention is also the use in a bitumen, of at least one combination of additives comprising at least one Tall Oil derivative and at least one fatty acid monoester, for reducing the manufacturing, processing and/or compacting temperatures of the bituminous mixes and the manufacturing and/or processing temperatures of the poured asphalts. The use of this combination of additives makes it possible to lower said temperatures of all the bitumens (hard grade bitumens, intermediate grade bitumens, soft grade bitumens), whatever their penetrability. Thus, the combination of additives is suited to the bitumens with a penetrability comprised between 35 and 50 1/10 mm and to the bitumens with a penetrability comprised between 10 and 20 1/10 mm. This combination of additives makes it possible to lower said temperatures while retaining the mechanical properties of the bituminous mixes and the poured asphalts, with very low additive contents.

The use of the combination of additives, during the manufacture of a mix, makes it possible to obtain manufacturing or coating temperatures between 100° C. and 150° C., preferably between 110° C. and 140° C., more preferentially between 120° C. and 130° C. The use of the combination of additives makes it possible to obtain processing temperatures during spreading between 80° C. and 130° C., preferably between 90° C. and 120° C., more preferentially between 100° C. and 110° C. The use of the combination of additives makes it possible to obtain compacting temperatures between 70° C. and 120° C., preferably between 80° C. and 110° C., more preferentially between 90° C. and 100° C.

The use of the combination of additives, during the manufacture of an asphalt, makes it possible to obtain manufacturing temperatures between 140° C. and 180° C., preferably between 150° C. and 170° C. The use of the combination of additives makes it possible to obtain processing temperatures between 120° C. and 160° C., preferably between 130° C. and 150° C.

The use of the combination of additives, during the manufacture of a mix, makes it possible to reduce the manufacturing temperatures by 10° C. to 80° C., preferably 20° C. to 60° C., more preferentially 30° C. to 50° C. The use of the combination of additives makes it possible to reduce the processing temperatures during spreading by 30° C. to 100° C., preferably 40° C. to 120° C., more preferentially 50° C. to 70° C. The use of the combination of additives makes it possible to reduce the compacting temperatures by 30° C. to 80° C., preferably 40° C. to 70° C., more preferentially 50° C. to 60° C.

Finally, a subject of the invention is the use of mixes and poured asphalts according to the invention for the manufacture of surfacing materials for roads, carriageways, footways, road systems, urban developments, floors, waterproofing of buildings or of civil engineering works, in particular for the manufacture in road applications of sub-base courses, base courses, foundation courses, surface courses such as binder courses and/or wearing courses.

### EXAMPLES

The different products used are the following:
a pure bitumen having a penetrability of 42 1/10 mm (according to the standard EN 1426) and a ring and ball temperature of 52.5° C. (according to the standard EN 1427),
a Tall Oil pitch, having an acid value comprised between 25 and 35 mg KOH/g, a saponification value comprised between 90 and 100 mg KOH/g and a softening point comprised between 20 and 40° C.,
a fatty acid methyl monoester comprising 18% by mass of palmitic acid C16:0, 51.4% by mass of oleic acid C18:1 and 19.8% by mass of linoleic acid C18:2 with an acid value comprised between 5 and 10 mg KOH/g and an iodine index comprised between 70 and 90 mg KOH/g.

Different bituminous binders are prepared:
The bituminous binder L1 is a control bituminous binder comprising no additives according to the invention. The bituminous binder L₁ is constituted by the pure bitumen described above.
The bituminous binder L₂ is a bituminous binder according to the invention to which the combination of additives according to the invention have been added. The bituminous binder L₂ comprises 99% by mass pure bitumen as defined above, 0.5% by mass Tall Oil pitch as defined above and 0.5% by mass fatty acid methyl monoester as defined above.
The bituminous binder L₃ is a bituminous binder according to the invention to which the combination of additives according to the invention have been added. The bituminous binder L₃ comprises 99% by mass pure bitumen as defined above, 0.6% by mass Tall Oil pitch as defined above and 0.4% by mass fatty acid methyl monoester as defined above.
The bituminous binder L₄ is a bituminous binder according to the invention to which the combination of additives according to the invention have been added. The bituminous binder L₄ comprises 99% by mass pure bitumen as defined above, 0.4% by mass Tall Oil pitch as defined above and 0.6% by mass fatty acid methyl monoester as defined above.

The bituminous binders L₂ to L₄ are prepared by mixing the bituminous binder L₁ and the combination of additives at a temperature of 120° C. The order of introduction of the two additives is not important, they can be added to the bituminous binder at the same time or one after the other. In this case they are added to the bituminous binder simultaneously.

TABLE 1
Properties of the bituminous binders

| | L₁ | L₂ | L₃ | L₄ |
|---|---|---|---|---|
| Penetrability at 25° C. (1/10 mm) ⁽¹⁾ | 42 | 50 | 47 | 54 |
| RBT (° C.) ⁽²⁾ | 52.5 | 50 | 51.2 | 49.5 |
| Viscosity at 160° C. (mm²/s) ⁽³⁾ | 200 | 180 | 190 | 150 |
| Viscosity at 140° C. (mm²/s) ⁽³⁾ | 550 | 500 | 530 | 450 |
| Viscosity at 120° C. (mm²/s) ⁽³⁾ | 1530 | 1375 | 1450 | 1300 |
| PI ⁽⁴⁾ | −1 | −1.2 | −1 | −1.1 |
| Adhesiveness (%)⁽⁵⁾ | 75 | 75 | 90 | 75 |
| Complex modulus E* (MPa) ⁽⁶⁾ | | | | |
| at 15° C. and 10 Hz | 185 | 150 | 165 | 135 |
| at 10° C. and 7.5 Hz | 290 | 245 | 255 | 230 |

⁽¹⁾ Penetrability P₂₅ measured at 25° C. according to the standard EN 1426.
⁽²⁾ Ring and Ball Temperature measured according to the standard EN 1427.
⁽³⁾ Viscosity at 120° C. measured according to the standard NF EN 12596.
⁽⁴⁾ Penetrability index (or Pfeiffer index).
⁽⁵⁾ Passive adhesiveness measured according to the standard PR NF EN 15626.
⁽⁶⁾ Complex modulus E* measured according to the standard NF EN 14770.

It is noted that the bituminous binders according to the invention L₂ to L₄ have properties equivalent to those of the control bituminous binder L₁ in terms of penetrability, Ring and Ball Temperature, plasticity range, adhesiveness and complex modulus. It is noted that the introduction of additives into the bituminous binders according to the invention L₂ to L₄, at a low temperature, due to the combination of particular additives utilized, does not degrade the properties of the bituminous binders according to the invention L₂ to L₄. The adhesiveness is even improved in the case of the bituminous binder according to the invention L₃. It is noted in particular that the particular combination of additives utilized does not affect the viscosity of the binder, does not reduce the viscosity of the binder, the viscosities at 120° C., 140° C. and 160° C. of the bituminous binders according to the invention L₁ to L₄ are comparable. The particular combination of additives utilized allows the reduction of the manufacturing temperatures despite an unchanged viscosity.

Control bituminous mixes and bituminous mixes according to the invention E₁, E₂, E₃ and E₄ respectively are then prepared from the control bituminous binders and bituminous binders according to the invention L₁, L₂, L₃ and L₄:
a control bituminous mix Eₗ, by mixing 94.6% by mass of aggregates and 5.4% by mass of control bituminous binder L₁, at a manufacturing temperature or coating temperature of 165° C., the aggregates and the bituminous binder both being at a temperature of 165° C., for 66 seconds. The bituminous binder/aggregates mixture is then spread at 155° C., compacted at 145° C. and cooled down to ambient temperature. The same mix prepared at a coating temperature of 120° C., a processing temperature of 100° C. and a compacting temperature of 80° C., cooled down to ambient temperature, gives a mixing time of 120 seconds.
a bituminous mix according to the invention E₂, by mixing 94.6% by mass of aggregates and 5.4% by mass of bituminous binder according to the invention L₂, at a manufacturing temperature or coating temperature of 120° C., the aggregates and the bituminous binder both being at a temperature of 120° C., for 68 seconds. The bituminous binder/aggregates mixture is then spread at 100° C., compacted at 80° C. and cooled down to ambient temperature.
a bituminous mix according to the invention E₃, by mixing 94.6% by mass of aggregates and 5.4% by mass of bituminous binder according to the invention L₃, at a manufacturing temperature or coating temperature of 120° C., the aggregates and the bituminous binder both being at a temperature of 120° C., for 69 seconds. The bituminous binder/aggregates mixture is then spread at 100° C., compacted at 80° C. and cooled down to ambient temperature.
a bituminous mix according to the invention E₄, by mixing 94.6% by mass of aggregates and 5.4% by mass of bituminous binder according to the invention L₄, at a manufacturing temperature or coating temperature of 120° C., the aggregates and the bituminous binder both being at a temperature of 120° C., for 75 seconds. The bituminous binder/aggregates mixture is then spread at 100° C., compacted at 80° C. and cooled down to ambient temperature.

It is noted that the coating times of the bituminous binders according to the invention E₂ to E₄ at a coating temperature of 120° C. are of the same order of magnitude as the coating time of the control bituminous binder E₁ at a coating temperature of 165° C., and are far less than the coating time of the control bituminous binder E₁ at a coating temperature of 120° C.

TABLE 2
Properties of the bituminous mixes

| | | | |
|---|---|---|---|
| E₁ | E₂ | E₃ | E₄ |

Duriez Test ⁽⁷⁾

| | | | | |
|---|---|---|---|---|
| Void content (%) | 11.2 | 10.8 | 10.6 | 11 |
| R (MPa) | 10.1 | 9.5 | 9 | 8 |
| r (MPa) | 8.3 | 7.9 | 7.5 | 6.5 |
| r/R | 0.82 | 0.83 | 0.84 | 0.80 |

Rutting test ⁽⁸⁾

| | | | | |
|---|---|---|---|---|
| Void content (%) | 6.9 | 7.2 | 7.5 | 7.2 |
| Rutting at 30, 000 cycles (%) | 4.2 | 5.3 | 4.9 | 6.0 |

Modulus test ⁽⁹⁾

| | | | | |
|---|---|---|---|---|
| Complex modulus (MPa) | 8300 | 7900 | 8100 | 7800 |

⁽⁷⁾ Test of resistance to stripping in water according to the standard NF P 98-251-1, reflects the adhesion between the bituminous binder and the aggregates.
⁽⁸⁾ Test of resistance to rutting according to the standard NF EN 12697-22, reflects the ability of the bituminous mix to resist creep associated with use under traffic conditions.
⁽⁹⁾ Measurement of the complex modulus of rigidity according to the standard NF P 98-260-1 or NF EN 12697-26, reflects the ability of the bituminous mix to bear stresses.

It is noted that the bituminous mixes according to the invention E₂, E₃ and E₄ have a resistance to stripping, identical to that of the control bituminous mix Eₗ, but with a manufacturing temperature less than 45° C., a processing temperature less than 55° C. and a compacting temperature less than 65° C. It is noted that the bituminous mixes according to the invention E₂, E₃ and E₄ have a resistance to rutting identical to that of the control bituminous mix E₁, but with a manufacturing temperature less than 45° C., a processing temperature less than 55° C. and a compacting temperature less than 65° C. It is noted that the bituminous mixes according to the invention E₂, E₃ and E₄ have a rigidity modulus virtually identical to that of the control bituminous mix E₁, but with a manufacturing temperature less than 45° C., a processing temperature less than 55° C. and a compacting temperature less than 65° C. It can therefore be concluded that the introduction of small quantities of additives into the bituminous mixes according to the invention E2, E3 and E4 makes it possible to reduce the manufacturing, processing and compacting temperatures of the mixes without degrading the mechanical properties of the bituminous mixes.

1-24. (canceled)

25. A bituminous binder comprising at least one bitumen and comprising from 0.1 to 5% by mass, relative to the mass of the bituminous binder, of at least one Tall Oil derivative, alone or in a mixture, and at least one fatty acid monoester.

26. The bituminous binder according to claim 25, comprising 0.5 to 5% by mass of Tall Oil derivative and fatty acid monoester, relative to the mass of bituminous binder.

27. The bituminous binder according to claim 25, comprising 0.1 to 1.5% by mass of Tall Oil derivative and fatty acid monoester, relative to the mass of bituminous binder.

28. The bituminous binder according claim 25, in which the Tall Oil derivative is chosen from the crude Tall Oils, distilled Tall Oils, Tall Oil fatty acids, Tall Oil resin acids and Tall Oil pitches, alone or in a mixture.

29. The bituminous binder according to claim 25, in which the fatty acid monoester is an alkyl monoester chosen from the methyl, ethyl, propyl, butyl monoesters, alone or in a mixture.

30. The bituminous binder according claim 25, in which the fatty acid of the fatty acid monoester is a fatty acid comprising 6 to 24 carbon atoms.

31. The bituminous binder according to claim 25, also comprising a polymer.

32. The bituminous binder according to claim 25, also comprising a cross-linking agent.

33. The bituminous binder according to claim 25, in which the mass ratio of the Tall Oil derivative to the fatty acid monoester is comprised between 5:95 and 45:55.

34. The bituminous binder according to claim 25, in which the mass ratio of the Tall Oil derivative to the fatty acid monoester is equal to 50:50.

35. The bituminous binder according to claim 25, in which the mass ratio of the Tall Oil derivative to the fatty acid monoester is comprised between 55:45 and 95:5.

36. The bituminous binder according to claim 25, in which the mixing temperature of the bitumen, the Tall Oil derivative and the fatty acid monoester is comprised between 100° C. and 170° C.

37. A bituminous mix comprising a bituminous binder according to claim 25, and aggregates comprising at least one of: fines, sand and chippings.

38. An asphalt comprising:
a bituminous binder at least one bitumen;
at least one Tall Oil derivative from 0.1 to 5% by mass, relative to the mass of the bituminous binder, alone or in a mixture;
at least one fatty acid monoester; and
fillers comprising at least one of: fines, sand and chippings.

39. The bituminous mix according to claim 37, comprising aggregates, in which the coating temperature is comprised between 100° C. and 150° C.

40. The bituminous mix according to claim 39, in which the bituminous binder and the aggregates are both at a temperature comprised between 100° C. and 150° C. during the coating.

41. The bituminous mix according to claim 39, in which the processing temperature during the spreading of the bituminous binder/aggregates mixture is comprised between 80° C. and 130° C.

42. The bituminous mix according to claim 39, in which the compacting temperature of the spread mixture is comprised between 70° C. and 120° C.

43. The asphalt according to claim 38, comprising fillers, in which the manufacturing temperature is comprised between 140° C. and 180° C.

44. The asphalt according to claim 43, in which the bituminous binder and the fillers are both at a temperature comprised between 140° C. and 180° C. during their mixing.

45. The asphalt according to claim 43, in which the processing temperature during the pouring of the bituminous binder/fillers mixture is comprised between 120° C. and 160° C.

46. A Tall Oil derivative, alone or in a mixture, and a fatty acid monoester for their use in a bituminous binder for reducing the manufacturing, processing and/or compacting temperatures of a bituminous mix or for reducing the manufacturing and/or processing temperatures of an asphalt.

47. The bituminous binder as defined in claim 25, having reduced manufacturing, processing and/or compacting temperatures of a bituminous mix or manufacturing and/or processing temperatures of an asphalt.

48. The asphalt according to claim 38, defining at least one of:
surfacing materials for roads, carriageways, footways, road systems, urban developments, floors, waterproofing of buildings, civil engineering works, road applications of sub-base courses, base courses, foundation courses, surface courses, binder courses, or wearing courses.
